(19) United States
(12) Patent Application Publication
(10) Pub. No.: US 2013/0282327 A1
(43) Pub. Date: Oct. 24, 2013

(54) DETERMINING ABSOLUTE POSITION IN DRIVE SYSTEMS

(71) Applicants: Marcus Gutzmer, Garbsen (DE); Uwe Krause, Pattensen (DE); Uwe Nolte, Barsinghausen (DE)

(72) Inventors: Marcus Gutzmer, Garbsen (DE); Uwe Krause, Pattensen (DE); Uwe Nolte, Barsinghausen (DE)

(21) Appl. No.: 13/977,771

(22) PCT Filed: Dec. 21, 2011
(86) PCT No.: PCT/EP11/73561

§ 371 Date: Jul. 1, 2013

(30) Foreign Application Priority Data
Dec. 30, 2010 (DE) 10 2010 056 467.2

(51) Int. Cl. G01B 5/14

(52) U.S. Cl. CPC G01B 5/14
USPC 702/150

(57) ABSTRACT

A method determines a position of at least one element that can be moved by a drive belt of a drive unit. A system is made of such components. A program carries out the method. In order to determine an absolute position of the movable element in a simple manner, the drive belt is expanded over a measurement interval and a force required to do so is determined via an efficiency of the drive unit. An effective length of the drive belt is determined from the measurement interval and the force and from a modulus of elasticity and a cross-section. The position is determined from the effective length.

### CROSS REFERENCE TO RELATED APPLICATIONS

This application is based on and hereby claims priority to International Application No. PCT/EP2011/073561 filed on Dec. 21, 2011 and German Application No. 10 2010 056 476.2 filed on Dec. 30, 2010, the contents of which are hereby incorporated by reference.

### BACKGROUND

The invention relates to a method for determining a position of at least one element which can be moved by a drive belt of a drive unit. The invention further relates to a system comprising a drive unit with a controller, it also relates to a program which is executed in such a controller.

Such a method, system and program can be used whenever the position of the element to be moved, e.g. an automatically operated door, must be known for the purpose of activating the drive unit (wherein the controller can also be integrated in the drive unit), since the activation of actuators is often dependent on the current position (of e.g. a motor-driven elevator door).

If an incremental sensor is used, a power failure must always be followed by an initialization run first, in order to determine at least an end position. Absolute value sensors which definitively capture the position, possibly via a plurality of revolutions (multiturn), are typically used here. A further possibility is measuring the separation via ultrasound. Methods are also known in which an incremental capture is continued even in the case of a power failure, such that no increments are lost.

Commonly cited in the related art is the use of incremental sensors or Hall sensors on the motor shaft of the drive system. The incremental approach is disadvantageous in this context, since “computation” is always based on a previously known position in this context. Moreover, the encoder is usually an optical encoder, which loses the sensor signal when the supply voltage is disconnected. In the case of absolute sensors, although an absolute position of the rotor sensor is available after a new “power on”, it does not usually correspond to the position of the movable element because, e.g. in the case of an automatically operated door, this absolute position occurs many times while the door travels through its full extent. In order to avoid this, a plurality of solutions have been applied until now:

1. Supply the sensor and the evaluation electronics for the time period during which the power supply is interrupted. This can be very expensive if a long bridging time is desired.

2. A mechanical storage system, e.g. a so-called multiturn encoder is formed by toothed wheels and possibly a plurality of sensors on the spindles, which encoder reproduces the whole of the possible door travel (for example) as an absolute sensor signal.

3. Capture by a wire cable and a magnetostrictive measuring principle. This is normally used to capture the cage position of elevators (during upward and downward travel).

4. Capturing linear positions by a code strip (optical or magnetic, or similar).

### SUMMARY

One potential object is simply to determine an absolute position of an element which can be moved by a drive system.

The inventors propose a method for determining a position of at least one element which can be moved by a drive belt of a drive unit, wherein the drive belt is expanded over a measurement interval and a force required to do so is determined via an efficiency of the drive unit, wherein an effective length of the drive belt is determined from the measurement interval and the force and from a modulus of elasticity and a cross-section, and wherein the position is determined from the effective length.

The inventors also propose a system and a program.

The absolute position of the drive (or of the movable element) is determined with reference to the measurement of the spring constant of the drive belt, where:

$$D = \frac{Δ F}{Δ s}$$

(quotient of force change and distance change).

The modulus of elasticity of the belt represents a material constant and can normally be considered constant in application. The relationship between modulus of elasticity and spring constant is shown by:

$$D = \frac{EA}{l}$$

(modulus of elasticity multiplied by the cross-section divided by the length).

Therefore the force which is required to tension or expand the belt by a specified distance is inversely proportional to the effective belt length, which can therefore be determined as follows:

$$l = EA \frac{Δ s}{Δ F} .$$

It is important to note in this case that the load (the movable element) which is driven by the belt should not move or should move so little as to have no influence on the result if the mass is not known. If the mass of the load is known, however, this influence can easily be excluded.

Furthermore, it must be possible to tension the belt so far that a measurable section is produced, and the inert mass of the belt must be significantly less than the load. Finally, the efficiency of the drive must be relatively well known or predictable, in order that a reliable value for the effective force can be obtained.

The effective length/is used to derive the absolute position of the movable element, either directly as a separation between drive unit and load, or indirectly by an offset value which takes the actual installation site into consideration and therefore specifies e.g. “closed”, “20 cm open” or “open” in respect of a door or two door panels, i.e. the closed position may be present in the case of a critical length of 60 cm, for example.

This value and the product of modulus of elasticity and cross-section are advantageously stored in a non-volatile memory, and can subsequently be used to determine the position of the load by a single measurement directly after switching on (power on).

The position can therefore be determined immediately by the proposed solution, rendering obsolete the previously common initialization run. In this way, the elastic property of a structurally important component is used to obtain positional information relating to the load without additional sensors being required for this purpose.

In an advantageous embodiment, the drive belt is pretensioned. In a further advantageous embodiment, the movable element is brought to a constant speed before the expansion of the drive belt. As a result of bringing the load to a low speed in advance or pretensioning the drive belt (if the load is at an end position or blocked), it is possible to increase the measurement accuracy and advantageously ensure that a small measurement interval is preserved. Errors due to play in the drive path or accelerated movements of the load are thereby avoided.

In a further advantageous embodiment, a product of modulus of elasticity and cross-section is determined during the course of a learning run, in which the force required for the expansion is determined in two positions having a known separation. As a result of this, the proposed solution can also be carried out without prior knowledge of the modulus of elasticity or measurement of the cross-section of the drive belt, since only the cited product is required for the purpose of determining the position. This product, expressed by the spring constants D₁ and D₂ at the two positions x₁ and x₂ having the separation x=x₂−x₁ as derived from the required forces for the respective measurement intervals according to the formula given above, is derived as follows:

$$EA = x \frac{{D}_{1} {D}_{2}}{{D}_{1} - {D}_{2}} .$$

The procedure can be largely automated in actual operation. For this purpose, a learning run is first performed as per the hitherto conventional method. Precise information about e.g. the full opening width is obtained by an incremental sensor in this case. In addition to this, a measurement of the spring constants is performed at both end positions. Two values are therefore obtained for the spring constant and, knowing the intermediate distance, the effective length of the belt can be determined via the product EA. Provision is made for taking further factors of influence into consideration at the same time, e.g. the efficiency of the motor.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

FIG. 1 shows a door mechanism as an exemplary system.

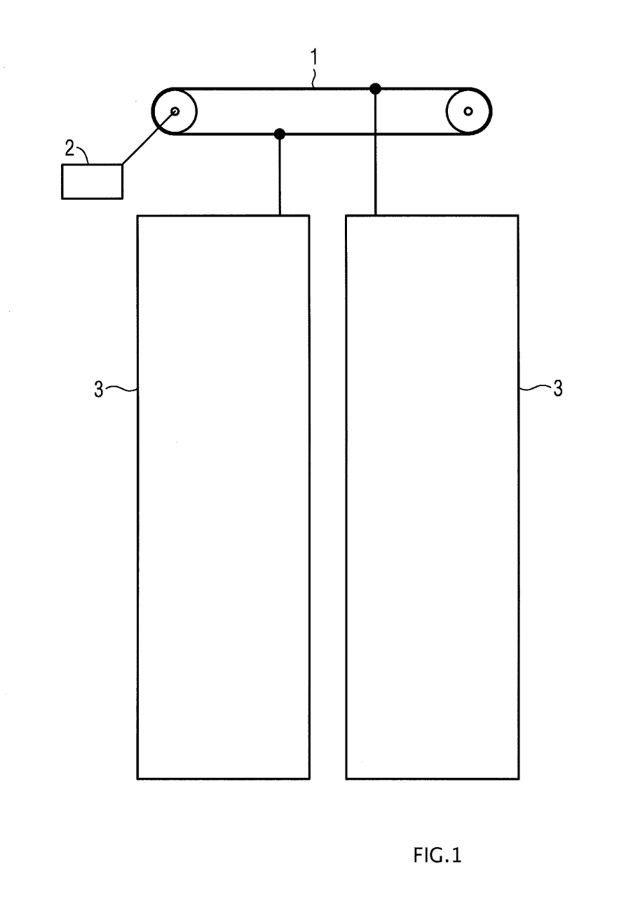

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The FIGURE shows a system according to the inventors' proposals, comprising a drive belt 1, a drive unit 2 and two elements 3 which can be moved by the belt 1 and are configured as door panels in the exemplary embodiment shown here. In order that the position of the door panels 3 can be determined when the modulus of elasticity and the cross-section of the drive belt 1 are not known, provision is first made for performing a learning run in which the product of these variables is calculated. For this purpose, the full opening width of the doors 3 is determined using an incremental sensor, and the spring constant of the belt 1 at both end positions is measured on the basis of a measurement interval over which the belt 1 is expanded, and the force that is required for the expansion, said force being derived from the efficiency of the motor 2. The aforementioned product can be calculated from the difference between the two end positions (the opening width) and the corresponding spring constants, and advantageously stored in a non-volatile memory of a controller of the motor 2, such that the position of the doors 3 can subsequently be determined by virtue of a single measurement.

For the purpose of actually determining the position, the controller briefly moves the motor 2 over a small measurement interval and determines the force that is required for this on the basis of the efficiency of the motor 2. It is important in this case that the inert mass of the belt 1 should be significantly less than that of the load 3, such that the belt 1 is ideally expanded without any movement of the door panels 3 in this case. The effective length of the belt 1 is now determined as described above on the basis of the measurement interval and the force that is required for the expansion, and the product of modulus of elasticity and cross-section of the drive belt 1. In conjunction with the knowledge of the end positions, which have been ascertained e.g. by the learning run, the positions of the door panels 3 are thus obtained and it is therefore then known whether the doors are closed, open or only 10 cm open, for example. By virtue of the proposed solution, the elastic property of a structurally important component is therefore used to obtain positional information relating to the load without additional sensors being required for this purpose.

In conclusion, the proposals relate to a method for determining a position of at least one element which can be moved by a drive belt of a drive unit. The proposals further relate to a system comprising such components and to a program for carrying out the method. In order to determine an absolute position of the movable element in a simple manner, a solution is proposed wherein the drive belt is expanded over a measurement interval and a force required to do so is determined via an efficiency of the drive unit, wherein an effective length of the drive belt is determined from the measurement interval and the force and from a modulus of elasticity and a cross-section, and wherein the position is determined from the effective length.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-6. (canceled)

7. A method for determining a position of an element which can be moved by a drive belt of a drive unit, comprising:
expanding the drive belt by a measurement interval;
determining a force required to expand the drive belt, the force being determined via an efficiency of the drive unit;
determining an effective length of the drive belt from the measurement interval, from the force, from a modulus of elasticity of the drive belt and from a cross-sectional area of the drive belt; and
determining the position from the effective length.

8. The method as claimed in claim 7, wherein
the drive belt is pretensioned before expanding the belt.

9. The method as claimed in claim 7, wherein
the element is brought to a constant speed before expanding the drive belt.

10. The method as claimed in claim 7, wherein
during a learning phase, the drive belt is expanded by the measurement interval while the element is at two known positions having a known separation, and
for each of the known positions, the force required to expand the belt is determined.

11. The method as claimed in claim 7, wherein
during a learning phase, the drive belt is expanded by the measurement interval while the element is at two known positions having a known separation,
for each of the known positions, the force required to expand the belt is determined, and
a product of the modulus of elasticity of the drive belt and the cross-sectional area of the drive belt is determined during the learning phase.

12. The method as claimed in claim 11, wherein
the product is determined from the force at each of the known positions, the measurement interval and the known separation.

13. The method as claimed in claim 7, wherein
the element is an automatically operated door,
the automatically operated door includes two door panels, and
the method determines the position of the two door panels.

14. A system comprising:
a drive unit;
an element;
a drive belt connecting the drive unit and the element, to move the element with force provided by the drive unit; and
a controller provided in the drive unit to:
expand the drive belt by a measurement interval;
determine a force required to expand the drive belt, the force being determined via an efficiency of the drive unit;
determine an effective length of the drive belt from the measurement interval, from the force, from a modulus of elasticity of the drive belt and from a cross-sectional area of the drive belt; and
determine the position from the effective length.

15. A non-transitory computer readable storage medium storing a program, which when executed by a controller, causes a system to perform a method for determining a position of an element which can be moved by drive belt of a drive unit, the method comprising:
expanding the drive belt by a measurement interval;
determining a force required to expand the drive belt, the force being determined via an efficiency of the drive unit;
determining an effective length of the drive belt from the measurement interval, from the force, from a modulus of elasticity of the drive belt and from a cross-sectional area of the drive belt; and
determining the position from the effective length.
